(19) United States
(12) Patent Application Publication
(10) Pub. No.: US 2026/0115738 A1
(43) Pub. Date: Apr. 30, 2026

(54) FLAT JET NOZZLE ARRANGEMENT

(71) Applicant: Alfred Kärcher SE & Co. KG, Winnenden (DE)

(72) Inventors: Tobias GELTZ, Winnenden (DE); Florian SEYBOLD, Winnenden (DE); Patrick FOLTYN, Winnenden (DE); Andreas FRIEDERICH, Winnenden (DE)

(21) Appl. No.: 19/429,823

(22) Filed: Dec. 22, 2025

Related U.S. Application Data
(63) Continuation of application No. PCT/EP2024/067506, filed on Jun. 21, 2024.

(30) Foreign Application Priority Data
Jul. 21, 2023 (DE) 10 2023 119 415.1

(51) Int. Cl. B05B 1/04

(52) U.S. Cl. CPC B05B 1/042

(57) ABSTRACT

A flat jet nozzle arrangement is provided, including a liquid nozzle part for dispensing a fan-shaped liquid jet defining a jet plane and a jet guidance part, and wherein the jet guidance part includes a through-channel having a liquid receiving portion, which receives the liquid jet and which is adjoined by a liquid dispensing portion that widens in the jet plane, and wherein the flat jet nozzle arrangement includes at least one air intake opening, which is in flow connection with the liquid receiving portion. In order to further develop the flat jet nozzle arrangement so that the ambient air impairs the liquid jet to a lesser extent, the liquid dispensing portion includes a longitudinal region, which extends at least over a portion of its total length and in which the liquid dispensing portion narrows perpendicularly to the jet plane with increasing distance from the liquid receiving portion.

### CROSS-REFERENCE TO RELATED APPLICATIONS

This application is a continuation of international application number PCT/EP2024/067506, filed on Jun. 21, 2024, and claims the benefit of German application number 10 2023 119 415.1, filed on Jul. 21, 2023, which applications are incorporated herein by reference in their entirety and for all purposes.

### BACKGROUND OF THE INVENTION

The invention relates to a flat jet nozzle arrangement comprising a liquid nozzle part and a jet guidance part, wherein the liquid nozzle part comprises a nozzle outlet opening for dispensing a fan-shaped liquid jet, said jet defining a jet plane, and wherein the jet guidance part comprises a through-channel having a liquid receiving portion, which receives the liquid jet dispensed by the liquid nozzle part and is adjoined by a liquid dispensing portion that widens in the jet plane, and wherein the flat jet nozzle arrangement comprises at least one air intake opening, which is in flow connection with the liquid receiving portion for introducing air into the liquid receiving portion.

Liquid nozzle parts for dispensing a fan-shaped liquid jet are used, for example, as accessories for high-pressure cleaning appliances in order to be able to pass over an object to be cleaned with a fanned out liquid jet. Pressurized water may be used as liquid, for example. Liquid nozzle parts of that kind are known from WO 2014/090333 A1 for example.

The fan-shaped liquid jet exiting the liquid nozzle part is subject to an interaction with the ambient air on its path to the object to be cleaned. This results in the liquid jet being decelerated and losing compactness. To counteract this effect, JP 2004-223409 A proposes a flat jet nozzle arrangement of the kind stated at the outset. In addition to a liquid nozzle part, the flat jet nozzle arrangement comprises a jet guidance part, by means of which air is able to be admixed to the liquid jet, the air forming an air jacket that surrounds the liquid jet and together with the liquid jet is able to be dispensed from the flat jet nozzle arrangement. The air jacket reduces the interaction of the liquid jet with the ambient air, wherein, in particular, the deceleration of the liquid jet is reduced and its compactness is less impaired.

The jet guidance part disclosed in JP 2004-223409 A comprises a through-channel having a liquid receiving portion and a liquid dispensing portion adjoining the latter in the flow direction of the liquid jet. The liquid receiving portion receives the liquid jet dispensed by the liquid nozzle part. The liquid receiving portion is adjoined by the liquid dispensing portion, wherein the latter expands in the jet plane so that the fan-shaped liquid jet is able to be flow unimpaired through the through-channel of the jet guidance part. Air can be fed to the liquid receiving portion by way of at least one air intake opening, such that a liquid-air mixture forms in the liquid receiving portion and the air is then able to flow through the liquid dispensing portion together with the liquid jet while forming an air jacket. The intake of air takes place by means of the liquid jet exiting the nozzle outlet opening of the liquid nozzle part with considerable speed in the manner of a jet pump.

By means of such flat jet nozzle arrangements, a deceleration of the liquid jet due to its interaction with the ambient air can be reduced, such that an improved cleaning effect is able to be achieved compared to typical liquid nozzle parts that dispense a fan-shaped liquid jet. However, it would be desirable if the influence of the ambient air on the liquid jet could be reduced further.

In accordance with an embodiment of the invention, a flat jet nozzle arrangement of the generic type is further developed in such a way that the surrounding air impairs the liquid jet to a lesser extent.

### SUMMARY OF THE INVENTION

In accordance with an embodiment of the invention, provision is made in a flat jet nozzle arrangement of the kind stated at the outset that the liquid dispensing portion comprises a longitudinal region, which extends at least over a portion of its entire length and in which the liquid dispensing portion narrows perpendicularly to the jet plane with increasing distance from the liquid receiving portion.

The flat jet nozzle arrangement in accordance with the invention comprises a jet guidance part having a liquid dispensing portion, which widens in the jet plane of the liquid jet with increasing distance from the liquid receiving portion and which comprises a longitudinal region extending at least over a portion of its total length, in which longitudinal region it narrows perpendicularly to the jet plane with increasing distance from the liquid receiving portion. The longitudinal region extending at least over a portion of the total length of the liquid dispensing portion, in which region the liquid dispensing portion narrows perpendicularly to the jet plane with increasing distance from the liquid receiving portion, counteracts an enlargement of the cross sectional area of the liquid dispensing portion that is caused by the widening of the liquid dispensing portion in the jet plane. This in turn counteracts a reduction of the flow speed of the air jacket that surrounds the liquid jet within the liquid dispensing portion. The flow speed of the air jacket is dependent on the size of the cross sectional area of the liquid dispensing portion. The more the cross sectional area increases with increasing distance from the liquid receiving portion, the more the flow speed of the air jacket decreases. The narrowing of the liquid dispensing portion perpendicular to the jet plane in the longitudinal region extending at least over a portion of the total length of the liquid dispensing portion can at least partially compensate for an enlargement of the cross section area due to the widening of the liquid dispensing portion in the jet plane. This in turn causes the flow speed of the air jacket surrounding the liquid jet in the circumferential direction within the liquid dispensing portion to be less impaired. The lesser impairment of the flow speed of the air jacket in turn causes the liquid jet to be decelerated less within the liquid dispensing portion and the compactness of the liquid jet to be less impaired. When using the flat jet nozzle arrangement in accordance with the invention to clean an object, an improved cleaning performance can thus be achieved. The liquid jet can also be fanned further out by means of the flat jet nozzle arrangement in accordance with the invention, such that a larger cleaning width is able to be achieved with the same cleaning performance.

The flat jet nozzle arrangement in accordance with the invention is suited, in particular, for use in pressure cleaning appliances that provide a cleaning liquid, preferably water, at a pressure of 10 bar to 3,000 bar, in particular 10 bar to 300 bar.

The longitudinal region of the liquid dispensing portion in which the latter narrows perpendicularly to the jet plane with increasing distance from the liquid receiving portion preferably extends over at least 50% of the total length of the liquid dispensing portion, in particular over at least 75%, for example at least 85%.

Provision may be made that the longitudinal region of the liquid dispensing portion in which the latter narrows perpendicularly to the jet plane with increasing distance from the liquid receiving portion is adjoined by an end region of the liquid receiving portion that expands perpendicularly to the jet plane with increasing distance from the liquid receiving portion or that remains constant with respect to its extent perpendicular to the jet plane.

It is particularly advantageous if the longitudinal region of the liquid dispensing portion in which the latter narrows perpendicularly to the jet plane with increasing distance from the liquid receiving portion extends over the entire length of the liquid dispensing portion. In such an embodiment of the invention, the aforementioned longitudinal region extends up to the free end of the liquid dispensing portion.

It is favorable if the size of the cross sectional area of the liquid dispensing portion is constant in the longitudinal region in which the liquid dispensing portion narrows perpendicularly to the jet plane with increasing distance from the liquid receiving portion. In such an embodiment of the flat jet nozzle arrangement in accordance with the invention, in the aforementioned longitudinal region, an enlargement of the cross sectional area of the liquid dispensing portion that is due to the widening thereof in the jet plane is completely compensated for by the narrowing perpendicular to the jet plane. The constant size of the cross sectional area in this longitudinal region of the liquid dispensing portion causes the flow speed of the intake air to remain practically constant within this longitudinal region. As a result, flow losses of the liquid jet within the liquid dispensing portion can be kept particularly low.

In a preferred embodiment of the invention, the nozzle outlet opening of the liquid nozzle part opens into the liquid receiving portion.

It is advantageous if the liquid receiving portion tapers over its entire length or at least in a partial region extending in the longitudinal direction of the liquid receiving portion with increasing distance from the nozzle outlet opening of the liquid nozzle part. In an embodiment of that kind, the cross section of the liquid receiving portion decreases at least in a partial region. The liquid receiving portion thus forms a channel constriction of the through-channel of the jet guidance part. The liquid receiving portion is in flow connection with the at least one air intake opening. The channel constriction increases the intake of air in the manner of a Venturi nozzle.

Preferably, the liquid receiving portion tapers perpendicularly to the jet plane of the liquid jet with increasing distance from the nozzle outlet opening. In an embodiment of that kind, the extent of the liquid receiving portion decreases perpendicularly to the jet plane with increasing distance from the nozzle outlet opening of the liquid nozzle part.

In the jet plane, the liquid receiving portion may have a constant extent over its entire length.

It is advantageous if the liquid receiving portion tapers continuously with increasing distance from the nozzle outlet opening. As a result, flow losses of the air drawn into the liquid receiving portion can be kept particularly low.

In particular, provision may be made that the liquid receiving portion tapers continuously over its entire length.

It is advantageous if the narrowest cross section of the tapering liquid receiving portion is arranged at a distance of 3 mm to 30 mm from the nozzle outlet opening. Such a positioning of the narrowest cross section of the liquid receiving portion makes it possible to draw in air particularly effectively.

In an advantageous embodiment of the invention, the longitudinal region of the liquid dispensing portion in which the liquid dispensing portion narrows perpendicularly to the jet plane with increasing distance from the liquid receiving portion directly adjoins the liquid receiving portion and the size of the cross sectional area of the liquid dispensing portion corresponds in this longitudinal region to the size of the cross sectional area of the liquid receiving portion that the latter has at its end pointing away from the nozzle outlet opening. As already mentioned, it is advantageous if the size of the cross sectional area of the liquid receiving portion decreases with increasing distance from the nozzle outlet opening. In an embodiment of that kind, the liquid receiving portion has the smallest cross sectional area at its end pointing away from the nozzle outlet opening. The size of this cross sectional area can then be maintained in the longitudinal region of the liquid dispensing portion directly adjoining the liquid receiving portion by said longitudinal region narrowing perpendicularly to the jet plane with increasing distance from the liquid receiving portion and widening in the jet plane.

It is favorable if the aforementioned longitudinal region of the liquid dispensing portion continuously narrows perpendicularly to the jet plane with increasing distance from the liquid receiving portion. As a result, flow losses of the air jacket that surrounds the liquid jet in the liquid dispensing portion are able to be kept particularly low.

In an advantageous embodiment of the invention, the extent of the liquid dispensing portion in the jet plane of the liquid jet is delimited by a first and a second channel wall of the though-channel, and the extent of the liquid dispensing portion perpendicular to the jet plane of the liquid jet is delimited by a third and a fourth channel wall, wherein the distance between the first and the second channel wall increases continuously with increasing distance from the liquid receiving portion and the distance between the third and the fourth channel wall in the aforementioned longitudinal region of the liquid dispensing portion decreases continuously with increasing distance from the liquid receiving portion.

It is favorable if the first channel wall and the second channel wall are of rectilinear or arcuately curved configuration.

The first channel wall and the second channel wall define the opening angle of the liquid dispensing portion in the jet plane. The opening angle is preferably 10° bis 60°, in particular 20° to 40°.

The third channel wall and the fourth channel wall in the aforementioned longitudinal region of the liquid dispensing portion are preferably of rectilinear or arcuately curved configuration.

In an advantageous embodiment of the invention, the through-channel of the jet guidance part comprises an inlet portion, which is arranged directly upstream from the liquid receiving portion and in which inlet portion the liquid nozzle part is arranged. The inlet portion thus forms a receiving space for the liquid nozzle part.

It is favorable if the nozzle outlet opening of the liquid nozzle part is arranged directly in the transition region between the inlet portion and the liquid receiving portion relative to the flow direction of the liquid jet, such that the liquid jet dispensed by the liquid nozzle part flows directly into the liquid receiving portion.

In an advantageous embodiment of the invention, within the inlet portion, the liquid nozzle part is surrounded in the circumferential direction at least partially by at least one interspace that extends up to the liquid receiving portion and is in flow connection with the at least one air intake opening. Air can be supplied to the liquid receiving portion by way of the interspace, the air being able to be admixed to the liquid jet, wherein an air jacket surrounding the liquid jet in the circumferential direction forms.

The liquid nozzle part is favorably held on a pipe piece for supplying pressurized liquid, wherein the pipe piece is held on a holding part of the flat jet nozzle arrangement that is releasably connectable to the jet guidance part. The pipe piece may be, for example, a jet pipe of a high-pressure cleaning appliance, by way of which liquid that was pressurized by the high-pressure cleaning appliance is able to be provided to the liquid nozzle part. The pipe piece is favorably held on the holding part that is releasably connectable to the jet guidance part.

The holding part may form, for example, a holding plate of the flat jet nozzle arrangement, which is fixable to a rear side of the jet guidance part and comprises a passage that is passed through by the pipe piece and at which the pipe piece is held, for example by forming a positive engagement.

The at least one air intake opening of the flat jet nozzle arrangement in accordance with the invention is preferably arranged on the holding part. The holding part may comprise at least one passage, which forms an air intake opening and which is adjoined, for example, by the interspace explained above that at least partially surrounds the liquid nozzle part in the circumferential direction.

In an advantageous embodiment of the invention, the at least one air intake opening is arranged on the jet guidance part. In an embodiment of that kind, the jet guidance part comprises not only a through-channel, but additionally at least one air intake opening that is in flow connection with the liquid receiving portion of the through-channel, such that air is able to be dawn in and admixed to the liquid jet.

The at least one air intake opening is favorably in flow connection with the liquid receiving portion by way of an air intake channel.

In order to keep flow losses of the air as low as possible, it is advantageous if the flow cross sections of the air intake opening and the air intake channel are at least as large as the smallest cross sectional area of the liquid receiving portion.

The jet guidance part preferably comprises two opposite air intake openings, which are each adjoined by a respective air intake channel.

The air intake channels are preferably oriented obliquely to the jet plane and are configured mirror-symmetrically to the jet plane.

As already mentioned, it is favorable if the flat jet nozzle arrangement is set up to dispense liquid at a pressure of 10 bar to 3,000 bar, in particular at a pressure of 10 to 300 bar. Such an embodiment of the flat jet nozzle arrangement is suited, in particular, as an accessory for pressure cleaning appliances.

The opening angle of the liquid dispensing portion widening in the jet plane is favorably 10° to 60°, in particular 20° to 40°.

It is particularly advantageous if the contours of the liquid receiving portion and the liquid dispensing portion downstream from the liquid nozzle part are of continuous configuration and are configured having a continuous tangent and transition into one another continuously and with a continuous tangent. The flow losses of the air drawn in and of the liquid jet can thereby be kept particularly low.

The flat jet nozzle arrangement is preferably set up for flow rates of pressurized liquid in the range between 0.1 m³/h to 3 m³/h, in particular between 0.15 m³/h and 1.3 m³/h. An embodiment of that kind is suited, in particular, for pressure cleaning appliances.

The size of the nozzle outlet opening is preferably 0.25 mm² to 5 mm², in particular 0.5 mm² to 2.5 mm².

The smallest cross sectional area of the favorably tapering liquid receiving portion is preferably at least 10 times the nozzle outlet opening.

The size of the at least one air intake opening is preferably at least 10 times the size of the nozzle outlet opening.

The subsequent description of advantageous embodiments of the invention serves in conjunction with the drawing for further explanation.

### BRIEF DESCRIPTION OF THE DRAWINGS

FIG. 1 shows a section view of a first embodiment of a flat jet nozzle arrangement perpendicular to the jet plane of a liquid jet;

FIG. 2 shows a section view of the flat jet nozzle arrangement from FIG. 1 in the jet plane;

FIG. 3 shows a section view of the flat jet nozzle arrangement along the line 3-3 in FIG. 1;

FIG. 4 shows a section view of the flat jet nozzle arrangement along the line 4-4 in FIG. 1;

FIG. 5 shows a side view of the flat jet nozzle arrangement in the direction of arrow A in FIG. 1;

FIG. 6 shows a side view corresponding to FIG. 5 of an alternative embodiment of the flat jet nozzle arrangement from FIG. 1;

FIG. 7 shows a section view of a second embodiment of a flat jet nozzle arrangement perpendicular to a jet plane of a liquid jet;

FIG. 8 shows a section view of the flat jet nozzle arrangement from FIG. 7 in the jet plane;

FIG. 9 shows a section view of a third embodiment of a flat jet nozzle arrangement perpendicular to a jet plane of a liquid jet;

FIG. 10 shows a section view of the flat jet nozzle arrangement from FIG. 9 in the jet plane;

FIG. 11 shows a section view of the flat jet nozzle arrangement along the line 11-11 in FIG. 9;

FIG. 12 shows a section view of the flat jet nozzle arrangement along the line 12-12 in FIG. 9;

FIG. 13 shows a side view of the flat jet nozzle arrangement in the direction of arrow B in FIG. 9;

FIG. 14 shows a section view of a fourth embodiment of a flat jet nozzle arrangement perpendicular to the jet plane of a liquid jet;

FIG. 15 shows a section view of the flat jet nozzle arrangement from FIG. 14 in the jet plane;

### DETAILED DESCRIPTION OF THE INVENTION

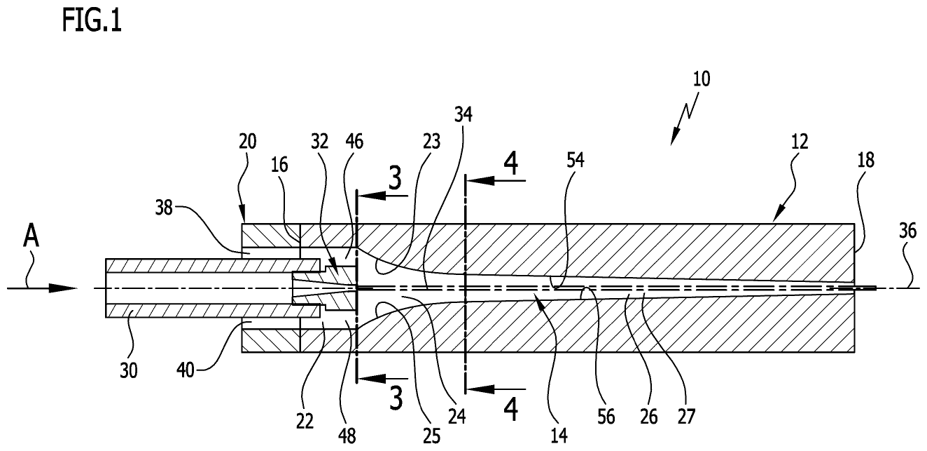

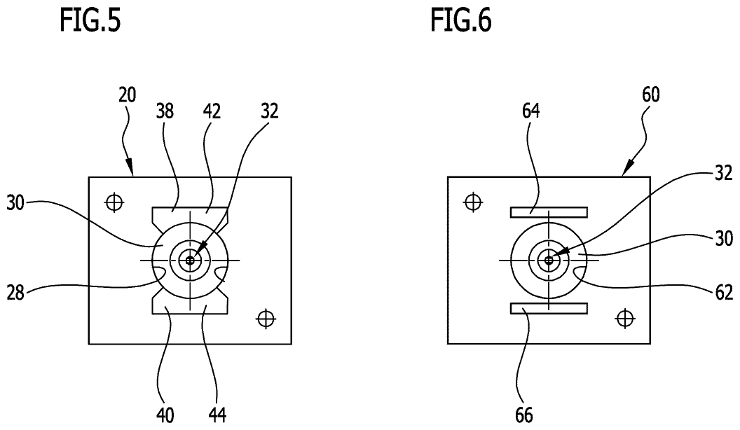

Schematically depicted in FIGS. 1 to 5 is a first advantageous embodiment of a flat jet nozzle arrangement in accordance with the invention, which is denoted as a whole with the reference numeral 10.

The flat jet nozzle arrangement 10 comprises a jet guidance part 12, which is passed through by a through-channel 14 that extends from a rear side 16 of the jet guidance part 12 up to a front side 18. Arranged on the rear side 16 is a holding element, which in the depicted embodiment is configured as a holding plate 20.

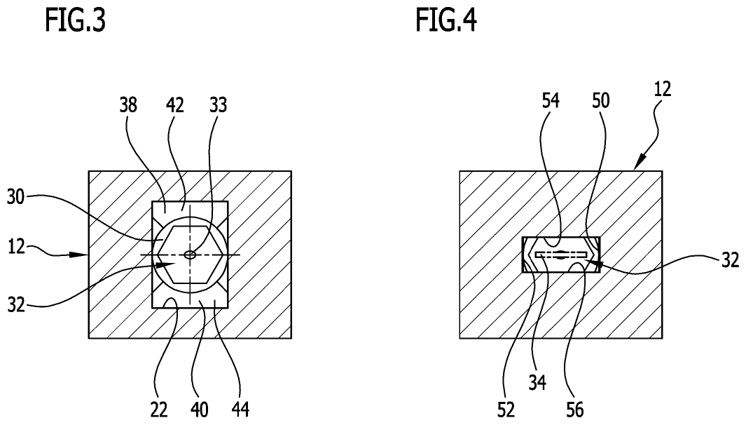

Commencing from the rear side 16, the through-channel 14 forms an inlet portion 22, which is directly adjoined by a liquid receiving portion 24. The liquid receiving portion 24 is directly adjoined by a liquid dispensing portion 26, which extends up to the front side 18 of the jet guidance part 12. The inlet portion 22 is of rectangular configuration in cross section, as can be seen in particular in FIG. 3.

The holding plate 20 comprises a passage opening 28, which is passed through by a pipe piece 30 that dips into the inlet portion 22 of the jet guidance part 12 and that bears a liquid nozzle part 32 at its end dipping into the inlet portion 22. By way of the pipe piece 30, pressurized cleaning liquid, in particular pressurized water, is able to be fed to the liquid nozzle part 32, said water being able to be dispensed by the liquid nozzle part 32 by way of a nozzle outlet opening 33 in the form of a fan-shaped liquid jet 34 that defines a jet plane 36.

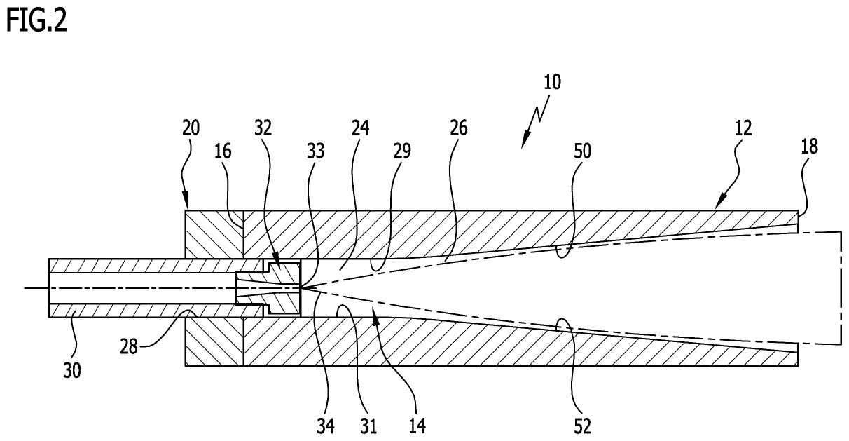

As can be seen in FIGS. 1 and 2, in the embodiment depicted, the liquid receiving portion 24 tapers perpendicularly to the jet plane 36 continuously over its entire length with increasing distance from the inlet portion 22. The liquid dispensing portion 26 adjoining the liquid receiving portion 24 continuously and with a continuous tangent widens in the jet plane 36 with increasing distance from the liquid receiving portion 24, whereas it continuously narrows perpendicularly to the jet plane 36 over its entire length with increasing distance from the liquid receiving portion 24. The liquid dispensing portion 26 thus comprises a longitudinal region 27 which extends over the entire length of the liquid dispensing portion 26 and in which the liquid dispensing portion 26 tapers continuously perpendicularly to the jet plane with increasing distance from the liquid receiving portion 24. Due to the continuous widening in the jet plane 36 and the continuous narrowing perpendicular to the jet plane 36, it is ensured that while the shape of the cross sectional area of the liquid dispensing portion 26 changes continuously with increasing distance from the liquid receiving portion 24, the size of the cross sectional area of the liquid dispensing portion 26 remains constant over its entire length. The size of the cross sectional area of the liquid dispensing portion 26 is identical to the size of the smallest cross sectional area of the liquid receiving portion 24 tapering continuously perpendicularly to the jet plane 36 of the liquid jet 34.

As can be seen in FIGS. 1 and 2, the channel walls 23, 25 delimiting the liquid receiving portion 24 perpendicularly to the jet plane 36 are arcuately curved in the direction toward the jet plane 36, whereas the channel walls 29, 31 delimiting the liquid receiving portion 24 in the jet plane 36 are of rectilinear configuration.

The pipe piece 30 is fixed in the passage opening 28, wherein the passage opening 28 comprises two opposing opening portions 38, 40, which adjoin opposing side regions of the pipe piece 30 and each form a respective air intake opening 42, 44 of the flat jet nozzle arrangement 10.

The liquid nozzle part 32 is surrounded within the inlet portion 22 in the circumferential direction by two half ring-shaped interspaces 46, 48, which adjoin the opening portions 38, 40 of the holding plate 20 and extend up to the liquid receiving portion 24.

Within the liquid receiving portion 24, a negative pressure forms due to the effect of the liquid jet 34, such that air is drawn into the liquid receiving portion 24 via the air intake openings 42, 44 and the interspaces 46, 48, said air being admixed to the liquid jet 34. An air jacket hereby forms, which surrounds the liquid jet 34 in the circumferential direction. The flow speed of the air jacket remains practically constant within the liquid dispensing portion 26, because the size of the cross sectional area of the liquid dispensing portion 26 remains constant over its entire length. Though the liquid dispensing portion 26 expands in the jet plane 36, the associated enlargement of the cross sectional area is compensated for by the narrowing of the liquid dispensing portion 26 perpendicularly to the jet plane 36. The practically constant flow speed of the air jacket results in the flow losses of the liquid jet 34 within the liquid dispensing portion 26 being able to be kept low, in particular the deceleration of the liquid jet 34 within the liquid receiving portion 24 can be kept low and the compactness of the liquid jet 34 is only slightly impaired.

The liquid dispensing portion 26 is delimited in the jet plane 36 by a first channel wall 50 and a second channel wall 52, and the liquid dispensing portion 26 is delimited perpendicularly to the jet plane 36 by a third channel wall 54 and a fourth channel wall 56 of the through-channel 14. The distance between the first channel wall 50 and the second channel wall 52 increases with increasing distance from the liquid receiving portion 24, whereas the distance between the third channel wall 54 and the fourth channel wall 56 continuously decreases with increasing distance from the liquid receiving portion 24. This is made clear in particular in FIGS. 1 and 2.

The channel walls 50, 52, 54, and 56 are each of rectilinear configuration in the embodiment depicted in FIGS. 1 to 5.

Depicted in FIG. 6 is an alternative configuration of the holding plate 20 in the form of a holding plate denoted as a whole with the reference numeral 60. The holding plate 60 differs from the holding plate 20 in that it comprises two passage slots 64, 66 in addition to a central passage opening 62. The central passage opening 62 is arranged between the two passage slots 64, 66 and accommodates the pipe piece 30 in a positive-locking manner.

The passage slots 64, 66 each form an air intake opening, by way of which the air drawn in is able to travel into the interspaces 46, 48 explained above, such that the air in the liquid receiving portion 24, as already explained above, is able to be admixed to the liquid jet 34 while forming an air jacket surrounding the liquid jet 34 in the circumferential direction.

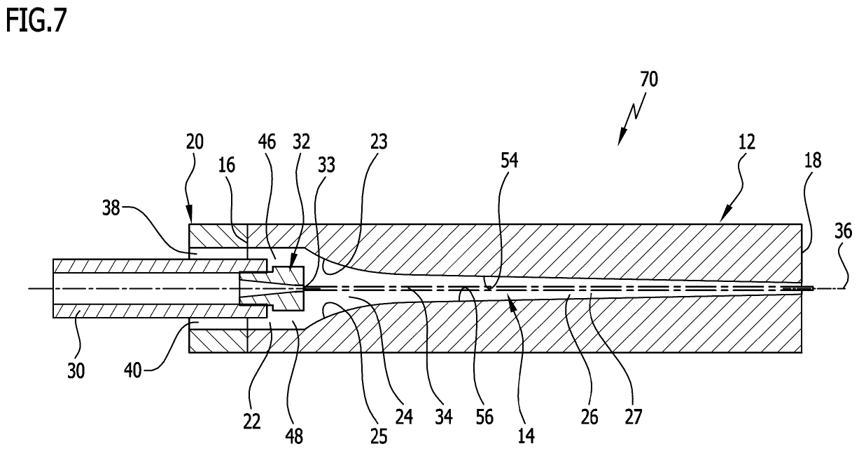

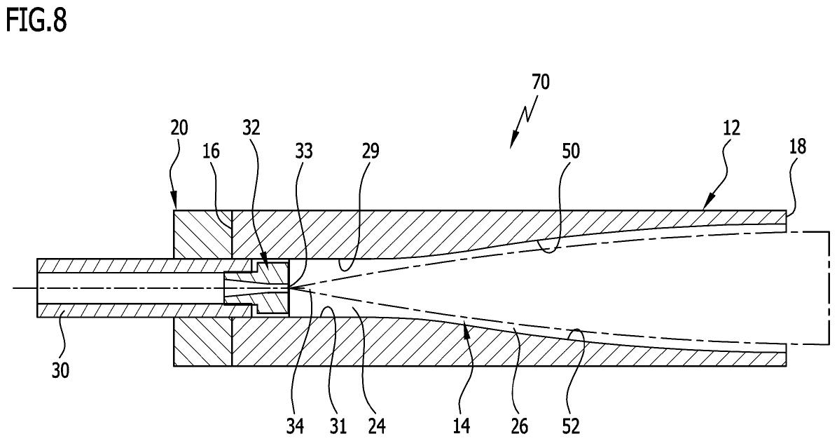

Schematically depicted in FIGS. 7 and 8 is a second advantageous embodiment of a flat jet nozzle arrangement in accordance with the invention, which is denoted as a whole with the reference numeral 70. The flat jet nozzle arrangement 70 is configured largely identical to the flat jet nozzle arrangement 10 described above with reference to FIGS. 1 to 5. Therefore, the same reference numerals are used in FIGS. 7 and 8 for identical components as in FIGS. 1 to 5, and to avoid repetition reference is made to the statements above regarding these components.

The flat jet nozzle arrangement 70 differs from the flat jet nozzle arrangement 10 in that the channel walls 50 and 52, which delimit the liquid dispensing portion 26 in the jet plane 36, are of arcuately curved.

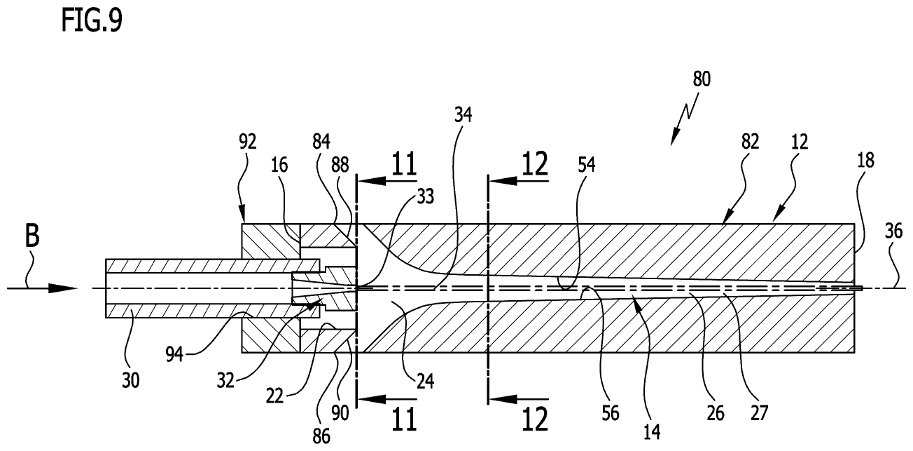

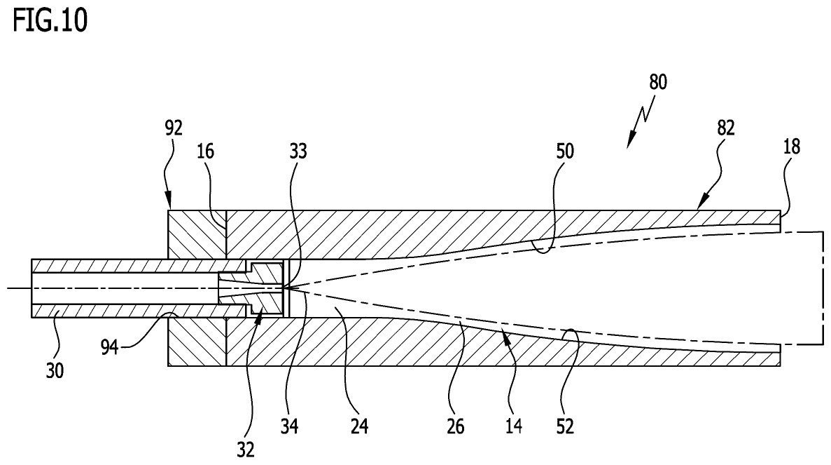

Schematically depicted in FIGS. 9 to 13 is a third advantageous embodiment of a flat jet nozzle arrangement in accordance with the invention, which is denoted as a whole with the reference numeral 80. The flat jet nozzle arrangement 80 is configured largely identical to the flat jet nozzle arrangement 10 described above with reference to FIGS. 1 to 5. Therefore, the same reference numerals are used in FIGS. 9 to 13 for identical components as in FIGS. 1 to 5, and to avoid repetition reference is made to the statements above regarding these components.

The flat jet nozzle arrangement 80 comprises a jet guidance part 82, which comprises a respective air intake opening 84, 86 on both sides of the jet plane 36, said air intake opening being adjoined by an air intake channel 88, 90 in the direction toward the liquid receiving portion 24. The air intake channels 88, 90 are oriented obliquely to the jet plane 36 and are configured mirror-symmetrically to the jet plane 36. By way of the air intake openings 84, 86 and the air intake channels 88, 90, air is able to be drawn into the liquid receiving portion 24, the air being subject to only very small flow losses due to the oblique position of the air intake channels 88, 90.

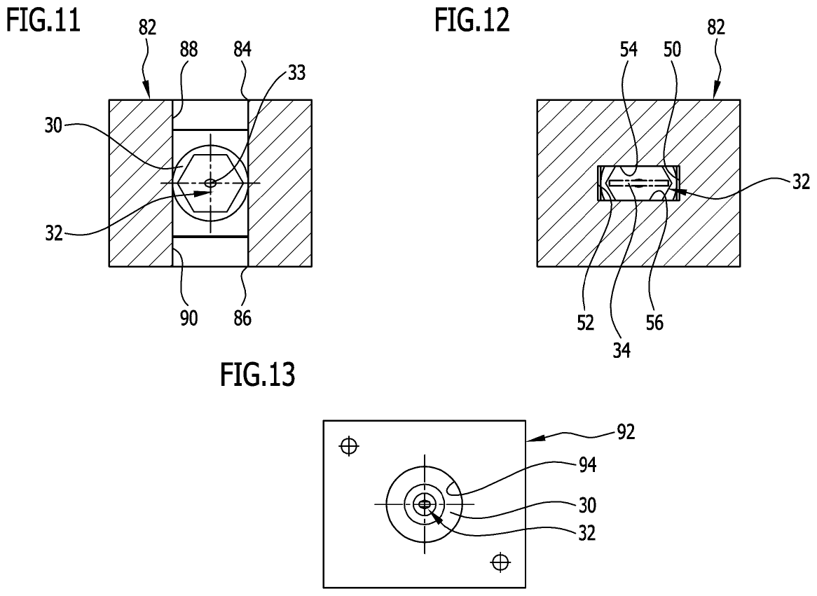

As can be seen in particular in the sectional depiction in FIG. 11, the air intake channels 88, 90 are of substantially slot-shaped configuration.

The flat jet nozzle arrangement 80 comprises a holding plate 92, which unlike the holding plates 20 and 60 described above comprises no air intake opening, but instead serves only to hold the pipe piece 30, which passes through a central passage opening 94 in a positive-locking manner.

In the case of the flat jet nozzle arrangement 80, too, the first and second channel walls 50, 52 that delimit the liquid dispensing portion 26 in the jet plane 36 are of arcuate configuration, whereas the channels walls 54, 56 that delimit the liquid dispensing portion 26 perpendicularly to the jet plane 36 are of rectilinear configuration.

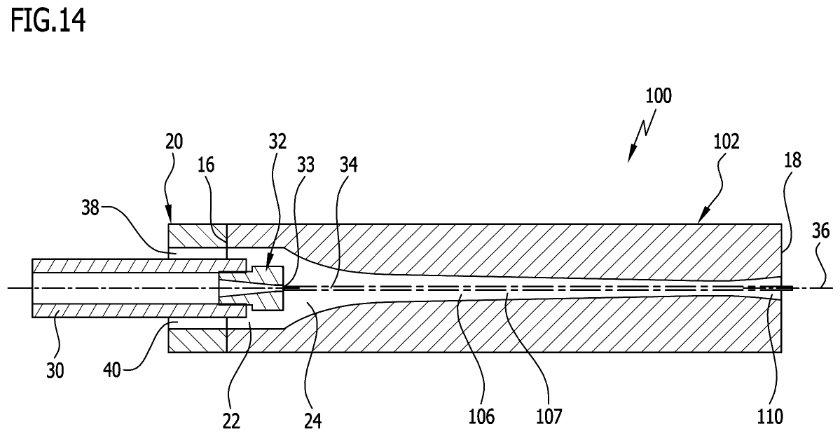

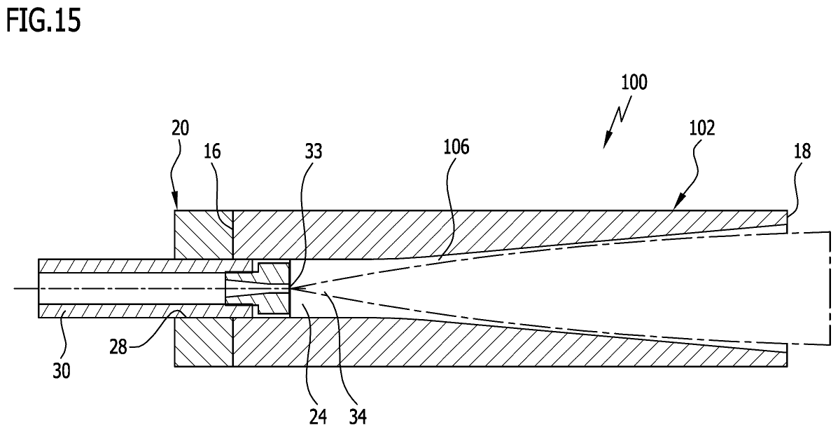

Schematically depicted in FIGS. 14 and 15 is a fourth advantageous embodiment of a flat jet nozzle arrangement in accordance with the invention, which is denoted as a whole with the reference numeral 100. The flat jet nozzle arrangement 100 is configured largely identical to the flat jet nozzle arrangement 10 described above with reference to FIGS. 1 to 5. Therefore, the same reference numerals are used in FIGS. 14 and 15 for identical components as in FIGS. 1 to 5, and to avoid repetition reference is made to the statements above regarding these components.

The flat jet nozzle arrangements 10, 70, and 80 described above each comprise a liquid dispensing portion 26 having a longitudinal region 27, which extends over the entire length of the liquid dispensing portion 26 commencing from the liquid receiving portion 24 up to the free end of the liquid dispensing portion 26 and in which the liquid dispensing portion 26 continuously narrows perpendicularly to the jet plane 36 with increasing distance from the liquid receiving portion 24. By contrast, the flat jet nozzle arrangement 100 comprises a jet guidance part 102 having a liquid dispensing portion 106, which comprises a longitudinal region 107 that extends only over a portion of the total length of the liquid dispensing portion 106 and that is adjoined by an end region 110 of the liquid dispensing portion 106, wherein the liquid dispensing portion 106 in the longitudinal region 107 continuously narrows perpendicularly to the jet plane 36 with increasing distance from the liquid receiving portion 24 and in the end region 110 continuously expands with increasing distance from the liquid receiving portion 24. The expanding end region 110 counteracts a drop formation at the free end of the liquid dispensing portion 106.

By means of the flat jet nozzle arrangements 10, 70, 80, and 100, a very compact, fan-shaped liquid jet can be formed, which within the jet guidance part is subject to only small flow losses, such that the flow speed of the liquid jet is only slightly reduced. This makes it possible to achieve a very good cleaning effect by means of the liquid jet produced in that way when the liquid jet is directed at an object to be cleaned.

1. A flat jet nozzle arrangement comprising a liquid nozzle part and a jet guidance part, wherein the liquid nozzle part comprises a nozzle outlet opening for dispensing a fan-shaped liquid jet, said jet defining a jet plane, and wherein the jet guidance part comprises a through-channel having a liquid receiving portion, which receives the liquid jet dispensed by the liquid nozzle part and which is adjoined by a liquid dispensing portion that widens in the jet plane, and wherein the flat jet nozzle arrangement comprises at least one air intake opening, which is in flow connection with the liquid receiving portion for introducing air into the liquid receiving portion, wherein the liquid dispensing portion comprises a longitudinal region extending at least over a portion of its total length, in which longitudinal region the liquid dispensing portion narrows perpendicularly to the jet plane with increasing distance from the liquid receiving portion.

2. The flat jet nozzle arrangement in accordance with claim 1, wherein said longitudinal region of the liquid dispensing portion extends over at least 50% of the total length of the liquid dispensing portion, in particular over at least 75%, for example at least 85%.

3. The flat jet nozzle arrangement in accordance with claim 1, wherein said longitudinal region of the liquid dispensing portion is adjoined by an end region of the liquid dispensing portion that expands perpendicularly to the jet plane of the liquid jet with increasing distance from the liquid receiving portion or that remains constant with respect to its extent perpendicular to the jet plane.

4. The flat jet nozzle arrangement in accordance with claim 1, wherein said longitudinal region of the liquid dispensing portion extends over the entire length of the liquid dispensing portion.

5. The flat jet nozzle arrangement in accordance with claim 1, wherein the size of the cross sectional area of the liquid dispensing portion is constant in said longitudinal region.

6. The flat jet nozzle arrangement in accordance with claim 1, wherein the nozzle outlet opening opens into the liquid receiving portion.

7. The flat jet nozzle arrangement in accordance with claim 1, wherein the liquid receiving portion tapers over its entire length or at least in a partial region extending in the longitudinal direction of the liquid receiving portion with increasing distance from the nozzle outlet opening of the liquid nozzle part.

8. The flat jet nozzle arrangement in accordance with claim 7, wherein the liquid receiving portion tapers perpendicularly to the jet plane of the liquid jet with increasing distance from the nozzle outlet opening.

9. The flat jet nozzle arrangement in accordance with claim 7, wherein the liquid receiving portion tapers continuously with increasing distance from the nozzle outlet opening.

10. The flat jet nozzle arrangement in accordance with claim 7, wherein the narrowest cross section of the liquid receiving portion is arranged at a distance of 3 mm to 30 mm from the nozzle outlet opening.

11. The flat jet nozzle arrangement in accordance with claim 1, wherein said longitudinal region of the liquid dispensing portion directly adjoins the liquid receiving portion and the size of the cross sectional area of the liquid dispensing portion in said longitudinal region corresponds to the size of the cross sectional area of the liquid receiving portion that the latter has at its end pointing away from the nozzle outlet opening.

12. The flat jet nozzle arrangement in accordance with claim 1, wherein said longitudinal region of the liquid dispensing portion continuously narrows perpendicularly to the jet plane of the liquid jet with increasing distance from the liquid receiving portion.

13. The flat jet nozzle arrangement in accordance with claim 1, wherein the extent of the liquid dispensing portion in the jet plane of the liquid jet is delimited by a first and a second channel wall, and wherein the extent of the liquid dispensing portion perpendicular to the jet plane of the liquid jet is delimited by a third and a fourth channel wall, wherein the distance between the first and the second channel wall continuously increases with increasing distance from the liquid receiving portion and the distance between the third and the fourth channel wall in said longitudinal region of the liquid dispensing portion continuously decreases with increasing distance from the liquid receiving portion.

14. The flat jet nozzle arrangement in accordance with claim 13, wherein the first channel wall and the second channel wall are of rectilinear or arcuately curved configuration.

15. The flat jet nozzle arrangement in accordance with claim 13, wherein the third channel wall and the fourth channel wall in said longitudinal region of the liquid dispensing portion are of rectilinear or arcuately curved configuration.

16. The flat jet nozzle arrangement in accordance with claim 1, wherein the through-channel comprises an inlet portion, which is arranged directly upstream from the liquid receiving portion and in which the liquid nozzle part is arranged.

17. The flat jet nozzle arrangement in accordance with claim 16, wherein the liquid nozzle part is surrounded within the inlet portion in the circumferential direction at least partially by at least one interspace, which extends up to the liquid receiving portion and is in flow connection with the at least one air intake opening.

18. The flat jet nozzle arrangement in accordance with claim 1, wherein the liquid nozzle part is held on a pipe piece for supplying pressurized liquid, wherein the pipe piece is held on a holding part of the flat jet nozzle arrangement that is releasably connectable to the jet guidance part.

19. The flat jet nozzle arrangement in accordance with claim 18, wherein the at least one air intake opening is arranged on the holding part.

20. The flat jet nozzle arrangement in accordance with claim 1, wherein the at least one air intake opening is arranged on the jet guidance part.

21. The flat jet nozzle arrangement in accordance with claim 20, wherein the at least one air intake opening is in flow connection with the liquid receiving portion by way of an air intake channel.

22. The flat jet nozzle arrangement in accordance with claim 21, wherein the jet guidance part comprises two opposing air intake openings, which are each adjoined by a respective air intake channel.

23. The flat jet nozzle arrangement in accordance with claim 22, wherein the air intake channels are oriented obliquely to the jet plane and are configured mirror-symmetrically to the jet plane.

24. The flat jet nozzle arrangement in accordance with claim 1, wherein the flat jet nozzle arrangement is set up to dispense liquid at a pressure of 10 bar to 3,000 bar, in particular at a pressure of 10 bar to 300 bar.

25. The flat jet nozzle arrangement in accordance with claim 1, wherein the opening angle of the liquid dispensing portion widening in the jet plane of the liquid jet is 10° to 60°, in particular 20° to 40°.

26. The flat jet nozzle arrangement in accordance with claim 1, wherein the contours of the liquid receiving portion and the liquid dispensing portion downstream from the liquid nozzle part are of continuous configuration and are configured with a continuous tangent and transition into one another continuously and with a continuous tangent.
